(19) United States
(12) Patent Application Publication
(10) Pub. No.: US 2026/0321526 A1
(43) Pub. Date: Oct. 15, 2026

(54) DC VOLTAGE SWITCHING DEVICE WITH INTEGRATED INTERRUPTION MECHANISM

(71) Applicant: Phoenix Contact GmbH & Co. KG, Blomberg (DE)

(72) Inventors: Tobias GROTE, Lüdge (DE); Lutz HEUER, Blomberg (DE); Detlev SCHÜRGENS, Blomberg (DE)

(21) Appl. No.: 19/108,401

(22) PCT Filed: Aug. 31, 2023
(86) PCT No.: PCT/EP2023/073942

§ 371 Date: Mar. 3, 2025

(30) Foreign Application Priority Data
Sep. 5, 2022 (BE) BE2022/5704

(51) Int. Cl. H01H 9/54; H01H 9/10; H01H 9/26; H01H 21/06; H01H 21/86

(52) U.S. Cl. CPC H01H 9/547; H01H 9/10; H01H 9/26; H01H 9/548; H01H 21/06; H01H 21/86; H01H 2009/265

(57) ABSTRACT

A DC voltage switching device for coupling a DC voltage load to a DC voltage source via a positive conductor and/or negative conductor, wherein the DC voltage switching device has a housing or is at least partially surrounded by a housing. Within the housing, at least one first switching element, in particular a semiconductor-based, electronically controllable switching element, is contained and is integrated into the positive conductor and/or into the negative conductor, for coupling and decoupling the DC voltage load. The housing of the DC voltage device has at least two housing parts that are mechanically coupled to one another and can be moved relative to one another. In a first position of these two housing parts, the housing is closed and in a second position of these two housing parts, the housing is open and at least one of the positive and negative conductors is interrupted due to the second position.

### FIELD

The invention relates to a DC voltage switching device for coupling a DC voltage load to a DC voltage source via a positive conductor and/or negative conductor.

### BACKGROUND

For coupling a DC voltage load, i.e. in particular to electrically couple or connect a DC voltage load to a DC voltage source, but also to electrically disconnect the DC voltage load, a DC voltage switching device is usually used. Both a positive conductor and/or a negative conductor, via which the DC voltage load is coupled to the DC voltage source, can be routed through the DC voltage switching device. Within the scope of the invention, the DC voltage load does not have to be a single load, but can also be composed of a group of DC voltage loads or be designed as a DC network with a plurality of DC voltage loads operated via it. In a practical embodiment, the positive conductor and the negative conductor thus each run advisably between an input connection of the DC switching device and an output connection of the DC switching device. Consequently, the two conductors are first electrically connected to a DC voltage source, e.g. a DC voltage bus, in particular via the two input terminals of the DC switching device, in order to apply an external DC voltage, and furthermore, in particular via the two output terminals of the DC switching device, are electrically connected to the DC voltage load to be connected to the DC voltage. For electrically switching on and off, i.e. for connecting and disconnecting, the DC voltage load, the DC switching device comprises at least a first switching element. A controllable semiconductor switching element is often used for this purpose, which is integrated therefore in the positive conductor running between the DC voltage source and the DC voltage load (or in a practical embodiment in particular between the respective input terminal and output terminal of the DC voltage switching device for the positive conductor) and/or is integrated therefore in the negative conductor running between the DC voltage source and the DC load (or, in a practical embodiment, in particular between the respective input terminal and output terminal of the DC switching device for the negative conductor). Furthermore, in a supplementary, expedient embodiment, at least one further switching element, in particular an electromechanical switching element, can also be provided in the positive conductor and/or in the negative conductor. If the semiconductor switching element is conductively switched and each of the at least one further switching element provided in the positive conductor and/or in the negative conductor, if present, is in a closed state, then a current flow occurs between the DC voltage source and the DC voltage load. This current flow can be prevented or interrupted in particular by switching off or opening the first switching element, i.e. in particular the semiconductor switching element.

In a practical embodiment, such a generic DC switching device conventionally has a housing in which its electronic and/or electrical components are at least partially accommodated, i.e. at least the first switching element. As is well known, such a housing provides protection against external influences, i.e. in particular mechanical and other environmental influences, but also protection for the environment, including persons, from potential impairment and harm caused by these components, e.g. the housing must protect people in particular from accidental contact with the enclosed device.

In particular, if the housing is designed to be maintenance-friendly, for example to replace individual components, these are therefore often subject to strict safety requirements with regard to protection for the environment, including persons.

### SUMMARY

Object of the invention is therefore to provide a DC voltage switching device of the same type which, in particular with a housing accessible for maintenance and in particular in a simple and cost-effective manner, offers further improved, highly effective protection for the environment, including persons.

The problem is solved according to the invention by a DC voltage switching device with the features according to claim 1. Useful embodiments or further developments are the subject of the claims dependent on claim 1.

Accordingly, for a DC voltage switching device which is set up for coupling a DC voltage load via a positive conductor and/or negative conductor to a DC voltage source and which has a housing or is at least partially surrounded by a housing within which at least a first switching element, in particular a semiconductor-based, electronically controllable switching element, is contained and is integrated in the positive conductor and/or in the negative conductor for coupling and decoupling the DC voltage load, it is proposed according to the invention that the housing has at least two housing parts which are mechanically coupled to one another and can be moved relative to one another, wherein in a first position of these two housing parts that can be moved relative to each other, the housing is closed and in a second position of the housing parts that can be moved relative to each other, the housing is open and at least one of the positive and negative conductors is interrupted due to the second position.

The DC switching device is thus designed with an integrated interruption mechanism, which is functionally set up in such a way that, by means of or due to the relative positions of two movable housing parts, either to effect a closed housing or to interrupt at least one of the positive and negative conductors when the housing is open.

In other words, the integrated interruption mechanism is set up in such a way that the possibility of an electrical connection, i.e. a coupling of the DC voltage load, is no longer possible or is effectively prevented even by the at least first switching element when the housing is open. When the housing is open, the DC voltage load is always in an electrically switched off, i.e. disconnected, state.

### BRIEF DESCRIPTION OF THE DRAWINGS

The invention is described in more detail below with reference to some preferred embodiments, with reference to the accompanying drawings. The drawings show:

FIG. 1 a highly simplified first preferred embodiment of a DC voltage switching device according to the invention with partially broken housing in closed state,

FIG. 2 a highly simplified sketch of the embodiment shown in FIG. 1 with the housing open,

FIG. 3: a highly simplified second preferred embodiment of a DC voltage switching device according to the invention with partially broken housing in closed state,

FIG. 4 a highly simplified sketch of the embodiment according to FIG. 3 with the housing open, and

FIG. 5: a highly simplified circuit diagram of a further preferred embodiment of a DC voltage switching device according to the invention.

The invention is described in more detail below with reference to the accompanying drawings with reference to preferred embodiments.

### DETAILED DESCRIPTION

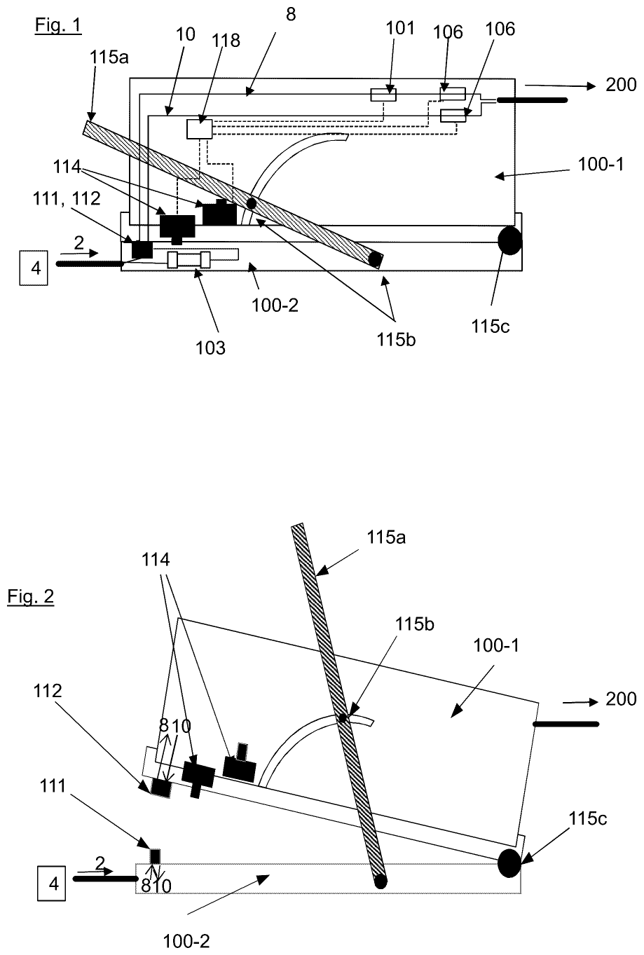

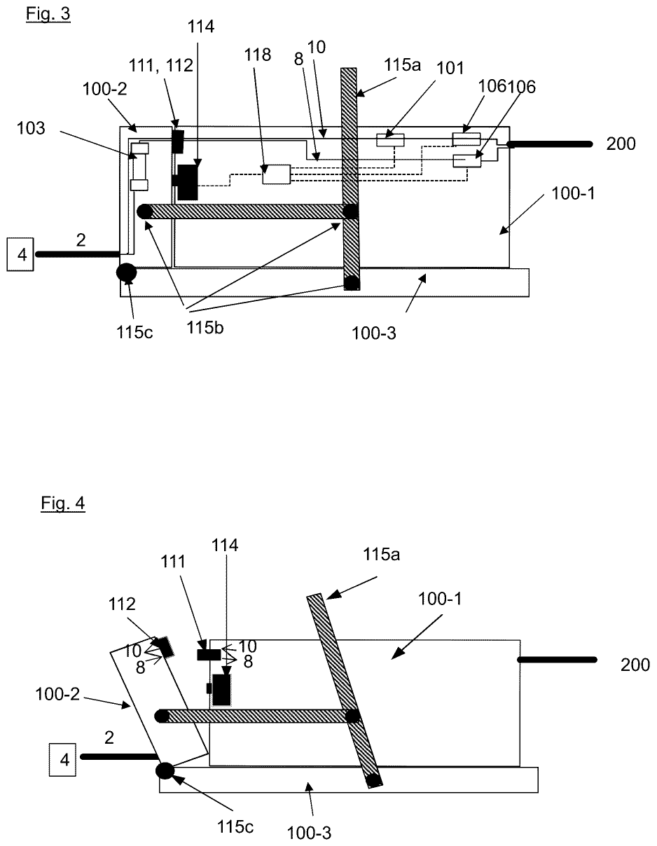

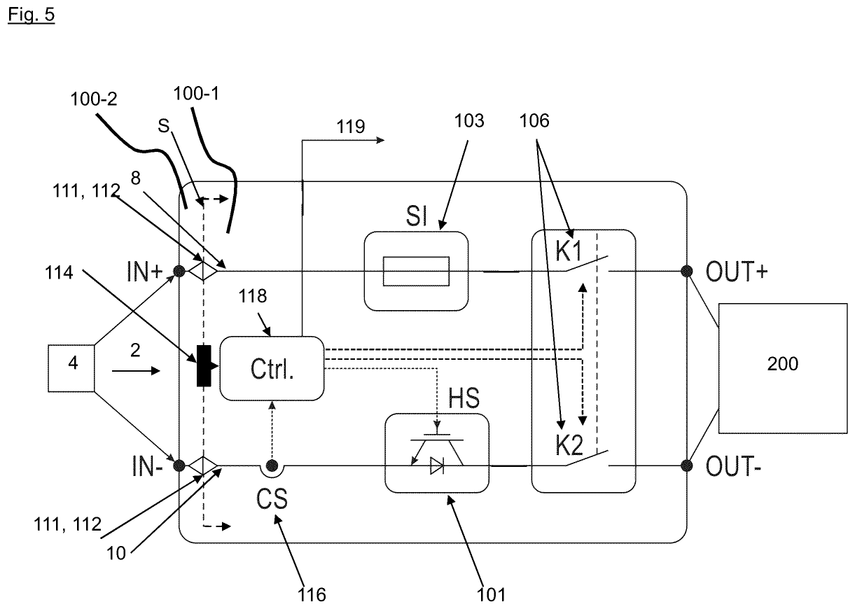

FIGS. 1 and 3 show, in greatly simplified form, a first and a second embodiment of a DC switching device 100 according to the invention, respectively, with the housing partially broken open in the closed state. FIG. 5 shows a highly simplified circuit diagram of a further preferred embodiment of a DC switching device 100 according to the invention.

In detail, FIGS. 1, 3 and 5, a DC voltage switching device 100 is shown which is set up for coupling a DC voltage load 200 to a DC voltage source 4 via a positive conductor 8 and/or negative conductor 10. The positive conductor 8 and the negative conductor 10 are each conveniently routed through the DC voltage switching device 100. A DC voltage branch 2 is set up between the DC voltage source 4 and the DC voltage load 200 by means of the DC voltage switching device 100. The positive and negative conductors 8, 10 can be can also arranged on a printed circuit board, i.e. in particular can be designed as conductor tracks.

As shown in the figures, the DC voltage switching device 100 as a housing constructed from at least two housing parts 100-1, 100-2, 100-3 or is at least partially surrounded by such a housing. In FIG. 1, the housing is therefore made up of the at least two housing parts 100-1, 100-2 and in FIG. 3, for example, of the three housing parts 100-1, 100-2 and 100-3. In FIG. 5, the dashed line S indicates the transition or “boundary” between two housing parts 100-1 and 100-2 of the DC voltage switching device 100.

Within the respective housing, as further shown in FIGS. 1, 3 and 5, at least one first switching element 101, suitably a semiconductor-based, electronically controllable switching element, is comprised, i.e. contained, and is integrated in the positive conductor 8 and/or in the negative conductor 10 for coupling and decoupling of the DC voltage load 200. In FIG. 1, only a first switching element 101 is integrated into the positive conductor 8 and in FIGS. 3 and 5 in the negative conductor 10. Furthermore, as shown in FIGS. 1, 3 and 5, at least one fuse 103 can be integrated in the positive conductor 8 and/or in the negative conductor 10. Such a fuse is in particular integrated at least in the conductor in which no first switching element 101 is integrated. Accordingly, in FIG. 1 a fuse 103, in particular a melting fuse, is integrated in the negative conductor 10 and in FIGS. 3 and 5 in the positive conductor 8, which is additionally marked with SI in FIG. 5. Such a fuse 103 is expediently replaceable and is thus expediently arranged so that it is accessible from outside the housing when the housing is opened, so that it can therefore be easily replaced, particularly in the event of “destruction”.

The switching element 101 is therefore used in particular for the operational switching of the DC switching device 100, but can also be used, in particular designed as a semiconductor switching element and additionally marked with HS in FIG. 5, for earth fault protection for the conductor in which it is integrated. Consequently, even in the event of an earth fault, the fault location can be disconnected from the rest of the network very quickly, preferably within a few μs, so that the current to be switched off does not become too high. The first switching element can therefore conveniently switch off the conductor in which it is integrated in a few μs and thus disconnect the DC voltage source from the fault location before the current becomes too high. As the first switching element 101, consequently, in practical implementation, in particular a semiconductor-based, electronically controllable switching element, e.g. designed as a MOSFET (“metal-oxide-semiconductor field-effect transistor”) or IGBT (“insulated gate bipolar transistor”) is suitable for quickly decoupling the DC voltage load 200 from the DC voltage source 4. On the other hand, fuses with sufficient short-circuit strength are also available, so that the conductor in which a fuse 103 is integrated, can be disconnected sufficiently quickly. Therefore, if both the positive pole and the negative pole have a voltage with respect to earth potential that would result in a very large fault current in the event of an earth fault, the DC voltage switching device according to the invention has a means of safely disconnecting both the positive and negative branches even in the event of such a fault.

The DC switching devices according to the invention are characterized in that the housing has at least two housing parts which are mechanically coupled to one another and can be moved relative to one another, i.e. according to the embodiments according to FIGS. 1, 3 and 5, at least two of the housing parts 100-1, 100-2, 100-3 are designed as housing parts which are mechanically coupled to each other and can be moved

These at least two of the housing parts 100-1, 100-2, 100-3 are furthermore mechanically coupled to one another and arranged to be movable relative to one another in such a way that in a first position of these housing parts movable relative to one, the housing is closed another (see, for example, FIGS. 1 and 3) and in a second position of the housing parts movable relative to one another, the housing is open and at least one of the positive and negative conductors 8, 10 is interrupted due to the second position. Such a second position is shown in particular in FIGS. 2 and 4, which are each strongly simplifies the embodiment according to FIGS. 1 and 3, but with the housing open and also only in sketch form. In particular, the electrical and electronic components already discussed above with reference to FIGS. 1 and 3 have been largely omitted in these sketches for reasons of clarity.

However, it can be seen in particular that an uninterrupted line routing as shown in FIG. 1 between the DC voltage source 4, starting virtually at the DC voltage branch 2 up to the DC voltage load 200, i.e. including the conductor 8 via the component designated 111, 112 and/or including the conductor 10 via the fuse 103 and the component designated 111, 112, is interrupted in a second position as shown in FIG. 2 due to this second position and is therefore impossible. Accordingly, an uninterrupted line routing as shown in FIG. 3 between the DC voltage source 4, starting virtually at the DC voltage branch 2 up to the DC voltage load 200, i.e. including the conductor 10 via the component designated 111, 112 and/or including the conductor 8 via the fuse 103 and the component designated 111, 112, is interrupted in a second position as shown in FIG. 4 due to this second position and is therefore impossible.

Consequently, by means of or due to the relative positions of the at least two movable housing parts 110-1 and 100-2, the DC switching device is designed with an integrated interruption mechanism which is functionally configured either to effect a closed housing, i.e. in the first position, or to interrupt at least one of the positive and negative conductors in an open housing, i.e. in the second position.

This integrated interruption mechanism is thus set up in such a way that the possibility of an electrical connection, i.e. a coupling of the DC voltage load 200, even by the at least first switching element 101, is no longer possible or effectively prevented when the housing is open in the second position of the housing parts 100-1 and 100-2 being movable relative to one another. When the housing is open, the DC voltage load 200 is always in an electrically disconnected, i.e. decoupled, state. In particular, in the open position, the DC voltage load 200 is disconnected from the DC voltage source 4 not only electrically but also galvanically decoupled, in practical implementation expedient with regard to both the positive conductor 8 and the negative conductor 10.

In order to interrupt at least one of the plus and negative conductors, two complementary electrical contact elements 111 and 112 are expediently arranged on the two housing parts 100-1 and 100-2 that can be moved relative to one another, which are in mutual electrical contact when the housing is closed and are electrically and galvanically isolated from one another when the housing is open. In particular, the component labeled 111, 112 in FIGS. 1, 3 and 5 thus comprises a first electrical contact element 111, for example a contact plug, on one of the two housing parts 100-1 and 100-2 which can move relative to one another, and a second electrical contact element 112, for example a contact socket, which is complementary thereto, on the other of the two housing parts 100-1 and 100-2 which can move relative to one another, as can be seen schematically in particular in FIGS. 2 and 4. This means that the components labeled 111, 112 in FIGS. 1 to 5 comprise, in practical implementation, two complementary electrical contact elements 111 and 112, to each of which the positive conductor 8 and the negative conductor 10 are electrically connected.

Alternatively or additionally, as can be seen schematically in particular from FIGS. 1 to 4, it can therefore also be expediently provided that each conductor of the two positive and negative conductors 8, 10 that is interrupted when the housing is open is routed through the housing and is electrically connected to a respective first conductor 111 of the complementary electrical contact elements within a first 100-1 or 100-2 of the two housing parts that can be moved relative to one another, and is electrically connected to a respective second contact element 112 of the complementary electrical contact elements within the second 100-1 or 100-2 of the two housing parts that can be moved relative to one another, wherein the respective first electrical contact element and the respective second electrical contact element are in mutual electrical contact when the housing is closed and electrically and galvanically isolated from each other when the housing is open.

Furthermore, it is advantageous if at least one signal generator 114 is additionally included, which is arranged and set up for signaling an opening movement in response to the movement of the two housing parts movable relative to one another from the first position in the direction of the second position.

Consequently, if the signal contact 114 is already opened in advance of the contact elements 111, 112 in the positive and/or negative conductor path 8, 10 when the housing is opened, i.e. before the housing is fully opened, a signal emitted or received by the signal contact 114, which thus signals in particular the opening movement, can be used to initially open the first switching element 101. This ensures that no arcing occurs in the positive and/or negative conductor path 8, 10 when the contacts in the power path contact elements 111, 112 are subsequently opened.

For this purpose, the DC voltage switching device can in particular have an evaluation device 118 connected to the signal generator 114 and the first switching element 101, which is set up to control at least the first switching element 101 to decoupling the DC voltage load in response to an opening movement signaled by the signal generator 114. In FIGS. 1, 3 and 5, preferred control paths of such an evaluation device 118 are shown in dashed lines.

As can be seen in FIGS. 1, 3 and 5, a second switching element 106, in particular an electromechanical switching element, in particular a relay contact, for coupling and decoupling the DC voltage load 200 can optionally be accommodated, in particular accommodated in the housing, which is integrated into one of the positive and negative conductors 8, 10. As can also be seen in the figures, however, a third switching element 106, in particular an electromechanical switching element, in particular a relay contact, for coupling and decoupling the DC voltage load 200 is also accommodated, in particular accommodated in the housing, which is integrated in the other of the positive and negative conductors 8, 10.

It is also advantageous if, in such a case, the evaluation device 118 is also connected to the second switching element 106 or also to the third switching element 106. By opening the signal generator 114 in advance, the signal signaling the opening movement can therefore also be used not only to initially open the first switching element 101, but additionally or alternatively also to initially open the second and, if necessary, also the third switching element 106. This also ensures that no arc is generated when the contacts in the power path contact elements 111, 112 in the positive and/or negative conductor path 8, 10 are subsequently opened.

In order to move the at least two housing parts 100-1, 100-2, 100-3, which are movable relative to one another, from the first position into the second position and vice versa, it is therefore further expedient to include an actuating mechanism 115a, 115b, 115c, which is arranged and set up accordingly for this purpose, in particular can be operated manually. Based on the embodiments outlined in the figures, the actuating mechanism for manual operation can thus have, for example, a manual actuator 115a, which is mechanically coupled to the at least two housing parts 100-1, 100-2, 100-3 which can be moved relative to one another via suitably arranged bearings 115b. However, as an alternative to the design of a manual actuator outlined in the figures, such a manual actuator or a similar manual actuator can also be mechanically coupled to the at least two housing parts 100-1, 100-2, 100-3, which are movable relative to one another, in a different manner or the actuating mechanism can also be designed differently overall, e.g. electrically, hydraulically or pneumatically. In addition, the actuating mechanism can furthermore be suitably designed to include suitable bearings 115c at least between the at least two housing parts 100-1, 100-2, 100-3 that are movable relative to one another, so that they can move relative to each other between the first position and the second position without having to be completely physically separated from each other in order to open the housing.

The evaluation device 118 can further be connected to a sensor 116 for evaluating a detected current flow, which sensor is expediently connected at least for detecting the current flow of the conductor in which the first switching element 101 is integrated. In FIG. 5, such a sensor 116, according to an expedient embodiment, has a sensor element arranged in series with the first switching element 101 for detecting the current flow of this conductor. The sensor element detecting this current flow is additionally marked with “CS”. In a practical embodiment, the evaluation device 118 can thus also be set up for comparing the detected current flow with respect to a threshold value and for activating the at least one switching element 101. For this purpose, the evaluation device 118 can have, for example, an analog circuit, a discrete circuit or preferably also a μC (microcontroller). If, depending on the embodiment and/or field of application, the current flow exceeds or falls below a threshold value, in particular a predetermined threshold value, the first switching element 101 for decoupling the load 200 from the source 4 is appropriately activated, i.e. in particular switched off, at least initially.

Consequently, if a second and possibly a third switching element 106 is also included for coupling and decoupling the DC voltage load 200, this can additionally also provide a galvanic decoupling of the load 200 from the source 4, in particular equally by means of the evaluation device 118. The second and third switching elements 106 can therefore also have relay contacts for this purpose, additionally marked with K1 or K2 in FIG. 5. However, such relay contacts are rather unsuitable for switching off, as the time until separation is in the ms range.

Consequently, if the current flow detected and evaluated by the evaluation device 118 exceeds a predetermined critical value, then, depending on the value exceeded and the special design, the first switching element 101 or, in addition, the second and third switching elements 106 can be switched off by the evaluation device 118 and the DC voltage branch can thus be disconnected electrically or galvanically decoupled from the DC voltage source 4. Furthermore, switching off the second and third switching elements 106 prevents the flow of current in both directions, whereas switching off only the first switching element 101 only prevents the flow of current in one direction. The second and third switching elements 106 therefore always ensure a safe galvanic isolation of the DC output from the DC input. Furthermore, the evaluation device 118 is preferably set up to take into account at least for switching off the first switching element 101 when a current flow rate, current amplitude and/or current direction predetermined by the threshold value is exceeded. In other words, as an alternative or in addition to the current amplitude in particular, the rate of change of current flow and/or the current direction can also be compared with a threshold value and, when exceeded, lead to the switching off of the first switching element (101). When evaluating against a threshold value, it is expedient to carry out, in addition to a comparison of the current amplitude, a comparison of the current flow rate of change and/or the current direction, leading to a switch-off if the threshold value is crossed.

In an expedient further development, the evaluation device 118 furthermore has a message output or a communication interface, namely for outputting 119 a message signal if the threshold value is crossed and/or if the threshold value is not crossed but the detected current flow has a greater value in magnitude than a second threshold value that is smaller in magnitude than the threshold value. This means that by the comparison with a threshold value, for example, tolerable current changes, fluctuations and/or losses during operation of the DC voltage load can also be taken into account in a versatile and flexible manner. Furthermore, the evaluation device 118 is not only appropriately designed and set up to cause the decoupling of the DC voltage load 200 or the entire DC voltage branch 2 electrically or additionally also galvanically from the DC voltage source 4 by means of corresponding activation commands to the first switching element 101 or the other switching elements 106, i.e. to switch it or them off, but also to cause the electrical and/or galvanic coupling of the DC voltage load 200 or the entire DC voltage branch 2 to the DC voltage source 4 by means of corresponding activation commands to the switching element or switching elements, i.e. to switch it or them on. In particular, a command to the evaluation device 118 for effecting the switch-on based on this can, according to an appropriate embodiment of the evaluation device 118, also be received for example via a communication interface as described above or via another input interface, in particular a digital input.

With a DC voltage switching device as described above in various embodiments, a switching system can therefore also be implemented in particular, in which the positive conductor 8 and the negative conductor 10 are connected to the DC voltage source 4 at an input IN+, IN− of the DC voltage switching device 100 and a DC voltage branch with the DC voltage load 200 can be connected and disconnected at an output OUT+, OUT− of the DC voltage switching device 100 via the positive conductor 8 and the negative conductor 10 (see FIG. 5). As a rule, the DC voltage of the DC voltage source 4 is usually supplied from a three-phase AC network with L1, L2, L3 by means of a rectification GR, whereby the rectification can be carried out actively with a power electronic circuit or passively with diodes.

Even if not shown in the figures, an electromechanical switching element can optionally be installed in parallel with the first switching element 101 and set up to assume a closed state in the coupled state of the first switching element 101. By means of such a configuration, the further electromechanical switching element arranged in parallel with the first switching element 101 can reduce a power loss if the first switching element 101 is in an electrically conductive state when this further electromechanical switching element arranged in parallel is closed. In particular, by additionally connecting the further electromechanical switch conduction losses of the first switching element 101 can also be reduced when the latter is in an electrically conductive state.

In view of the above description, the DC voltage load does not necessarily have to be a single load but can be made up of a group of DC voltage loads or designed as a DC network with a large number of DC voltage loads operated above it.

In summary, it can therefore be stated in particular that the invention proposes an additional disconnecting function or an additional interrupting mechanism. This is particularly advantageous if, for example, the normative requirements for a DC voltage switching device, i.e. generally for circuit breaker cannot be met. At least two parts of a device housing are designed to be movable relative to each other and mechanically coupled to each other, so that there is a closed housing position in a first position and an open housing position in a second position. At least two of these movable housing parts each contain electrical contact elements which are designed to be complementary to each other, so that when the housing is closed, the electrical contact elements are also closed and a current flow from the device input to the device output is basically possible. When the housing is open, the electrical contact elements are also open and consequently, a current flow from the device input to the device output is no longer possible in any case, as the device input is electrically and galvanically isolated from the device output by the open contact elements. In addition to these contact elements in the positive and/or negative branch, it is advisable to provide at least one additional signal contact or signal generator which, during the opening process, leads the electrical contact elements in the plus and/or minus branch.

By opening the signal contact or signal generator, it is therefore possible to control early deactivation, in particular individual and flexible deactivation, of switching elements contained in the DC voltage device, i.e. in particular one or more semiconductor switches and/or relay contacts. This ensures that during the opening process the electrical shutdown occurs before the electrical contact elements in the positive and/or negative branch are opened, thus preventing arcing.

### List of Reference Signs

2 DC voltage branch
4 DC voltage source
8 positive conductor
10 negative conductor
100 DC voltage switching device
100-1, 100-2, 100-3 housing parts of the DC voltage switching device
101 first switching element
103 fuse
106 second, third switching element
111, 112 electrical contact elements
114 signal generator
115a, 115b, 115c actuating mechanism
116 sensor
118 evaluation device
119 output from signal output or communication interface
200 DC voltage load
S transition or boundary between two housing parts of the DC voltage switching device

1. A DC voltage switching device for coupling a DC voltage load via a positive conductor and/or negative conductor to a DC voltage source, wherein the DC switching device comprises:
a housing or is at least partially surrounded by a housing and wherein an inside of the housing includes:
at least one first switching element integrated into the positive conductor and/or into the negative conductor for coupling and decoupling the DC voltage load,
wherein the housing has at least two housing parts which are mechanically coupled to one another and can be moved relative to one another, wherein in a first position of these two housing parts the housing is closed, and in a second position of the housing parts the housing is opened and at least one of the positive and negative conductors is interrupted due to the second position.

2. The DC voltage switching device according to claim 1,
wherein to interrupt at least one of the positive and negative conductors, complementary electrical contact elements are arranged on the two housing parts which are movable relative to one another, which are in mutual electrical contact when the housing is closed and are electrically and galvanically isolated from one another when the housing is open, and/or
wherein the at least one of the positive and negative conductors which is interrupted when the housing is open, is guided through the housing and is electrically connected, within a first of the two housing parts, to a respective first contact element of the complementarily formed electrical contact elements and is electrically connected, within the second of the two relatively housing parts, to a respective second contact element (112) of the complementary electrical contact elements, wherein the respective first electrical contact element and the respective second electrical contact element being in mutual contact when the housing is closed, electrically and galvanically isolated from each other when the housing is open.

3. The DC voltage switching device according to claim 1, further comprising at least one signal generator arranged and configured to signal an opening movement in response to the movement of the two relatively movable housing parts from the first position towards the second position.

4. The DC voltage switching device according to claim 3, which further comprises an evaluation device connected to the signal generator and the first switching element, which is configured to control at least the first switching element to decoupling the DC voltage load in response to an opening movement signaled by the signal generator.

5. The DC voltage switching device according to claim 1, further comprising a second switching element for coupling and decoupling the DC voltage load, housing, wherein the second switching element is integrated into one of the positive and negative conductors.

6. The DC voltage switching device according to claim 5, wherein further comprising a third switching element for coupling and decoupling the DC voltage load, which is integrated into the other one of the positive and negative conductors.

7. The DC voltage switching device according to claim 4, wherein the housing further includes a second switching element comprising an electromechanical switching element for coupling and decoupling the DC voltage load, wherein the second switching element is integrated into one of the positive and negative conductors, and wherein the evaluation device is also connected to the second switching element.

8. The DC voltage switching device according to claim 4, wherein the housing further includes:
a second switching element comprising an electromechanical switching element for coupling and decoupling the DC voltage load, wherein the second switching element is integrated into one of the positive and negative conductors, and
a third switching element comprising an electromechanical switching element for coupling and decoupling the DC voltage load, which is integrated into the other one of the positive and negative conductors,
wherein the evaluation device is also connected to the third switching element.

9. The DC voltage switching device according to claim 1, wherein a fuse is integrated in the positive conductor and/or in the negative conductor, which fuse is integrated within the housing and is replaceable and is accessible from outside the housing when the housing is open.

10. The DC voltage switching device according to claim 1, further comprising:
an actuating mechanism arranged and set up for moving the two housing parts relative to one another from the first position to the second position and vice versa, and/or
an electromechanical switching element is connected in parallel with the first switching element and set up such to assume a closed state in the coupled state of the first switching element.

11. The DC voltage switching device according to claim 1, wherein the at least one first switching element comprises a semiconductor-based, electronically controllable switching element.

12. The DC voltage switching device according to claim 5, wherein the second switching element comprises an electromechanical switching element.

13. The DC voltage switching device according to claim 5, wherein the second switching element is accommodated in the housing.

14. The DC voltage switching device according to claim 6, wherein the third switching element comprises an electromechanical switching element.

15. The DC voltage switching device according to claim 6, wherein the third switching element is accommodated in the housing.

16. The DC voltage switching device according to claim 1, wherein a fuse is integrated in the one of the positive and negative conductors in which the first switching element is not integrated, which fuse is integrated within the housing and is replaceable and is accessible from outside the housing when the housing is open.

17. The DC voltage switching device according to claim 1, wherein the actuating mechanism is manually operable.
